(19) United States
(12) Patent Application Publication
(10) Pub. No.: US 2026/0167503 A1
(43) Pub. Date: Jun. 18, 2026

(54) PROCESS FOR THE PREPARATION OF ELECTROACTIVE COMPOSITE PARTICLES

(71) Applicant: NEXEON LIMITED, Abingdon Oxfordshire (GB)

(72) Inventors: Silo MEOTO, Abingdon Oxfordshire (GB); Charles MASON, Abingdon Oxfordshire (GB)

(21) Appl. No.: 19/125,909

(22) PCT Filed: Oct. 31, 2023
(86) PCT No.: PCT/GB2023/052842

§ 371 Date: Apr. 30, 2025

(30) Foreign Application Priority Data
Oct. 31, 2022 (GB) 2216147.5

(51) Int. Cl. C01B 33/027

(52) U.S. Cl. CPC C01B 33/027; C01P 2002/88; C01P 2006/12; C01P 2006/14

(57) ABSTRACT

The invention relates to a process for preparing composite particles. The process comprises the steps of providing a plurality of porous particles comprising micropores and/or mesopores; contacting the porous particles with a silicon-containing precursor at a temperature effective to cause deposition of a plurality of silicon domains in the pores of the porous particles; subjecting the particles to heat treatment at a temperature of at least 400° C. and in the presence of an inert gas; and contacting the particles with a silicon-containing precursor at a temperature effective to cause deposition of further silicon domains in the pores of the porous particles.

### INTRODUCTION

This invention relates to a process for the preparation of composite particles comprising silicon deposited into the pores of porous particles. The process of the invention involves a step of heating the composite particles after silicon is deposited. The composite particles are useful as electroactive materials in the electrodes of rechargeable metal-ion batteries. In particular, the process of the invention enables the preparation of composite particles having high electrochemical capacities that are suitable for use as anode active materials in rechargeable metal-ion batteries. The invention also relates to novel composite particles that are prepared by the method of the invention.

### BACKGROUND

Lithium-ion batteries (LIBs) comprise in general an anode, a cathode and a lithium-containing electrolyte. The anode generally comprises a metal current collector provided with a layer of an electroactive material, defined herein as a material which is capable of inserting and releasing lithium ions during the charging and discharging of a battery. When a LIB is charged, lithium ions are transported from the cathode via the electrolyte to the anode and are inserted into the electroactive material of the anode as intercalated lithium atoms. The terms “cathode” and “anode” are therefore used herein in the sense that the battery is placed across a load, such that the anode is the negative electrode. The term “battery” is used herein to refer both to devices containing a single lithium-ion cell and to devices containing multiple connected lithium-ion cells.

LIBs were developed in the 1980s and 1990s and have since found wide application in portable electronic devices. The development of electric or hybrid vehicles in recent has created a significant new market for LIBs and renewable energy sources have created further demand for on-grid energy storage which can be met at least in part by LIB farms. Overall, global production of LIBs is projected to grow from around 290 GWh in 2018 to over 2,000 GWh in 2028.

Alongside the growth in total storage capacity, there is significant interest in improving the gravimetric and/or volumetric capacities of rechargeable metal-ion batteries such that the same energy storage is achieved with less battery mass and/or less battery volume. Conventional LIBs use graphite as the anode electroactive material. Graphite anodes can accommodate a maximum of one lithium atom for every six carbon atoms resulting in a maximum theoretical specific capacity of 372 mAh/g in a lithium-ion battery, with a practical capacity that is somewhat lower (ca. 340 to 360 mAh/g).

Silicon is a promising alternative to graphite because of its very high capacity for lithium (see, for example, Insertion Electrode Materials for Rechargeable Lithium Batteries, Winter, M. et al. in Adv. Mater. 1998, 10, No. 10). Silicon has a theoretical maximum specific capacity of about 3,600 mAh/g in a lithium-ion battery (based on Li₁₅Si₄). However, such a high ratio of intercalated lithium to silicon results in expansion of the silicon material by up to 400% of its original volume. Repeated charging and discharging cycles result in significant mechanical stress on the silicon material leading to fracturing and structural failure. Furthermore, the charging of anodes in LIBs results in the formation of a solid electrolyte interphase (SEI) layer. This SEI layer is an ion-conductive yet insulating layer that is formed by the reductive decomposition of electrolytes on exposed electrode surfaces during the initial charge. In a graphite anode, this SEI layer is relatively stable during subsequent charge/discharge cycles. However, the expansion and contraction of a silicon anode results in fracturing and delamination of the SEI layer and the exposure of fresh silicon surface, resulting in further electrolyte decomposition, increased thickness of the SEI layer and irreversible consumption of lithium. These failure mechanisms collectively result in an unacceptable loss of electrochemical capacity over successive charging and discharging cycles.

The present inventors have previously reported the development of a class of electroactive materials having a composite structure in which electroactive materials, such as silicon, are deposited into the pore network of highly porous particles, e.g. a porous carbon material, having a carefully controlled pore size distribution. For example, WO 2020/095067 and WO 2020/128495 report that the improved electrochemical performance of these materials can be attributed to the way in which the electroactive materials form small domains with dimensions of the order of a few nanometres or less within the pore network of the porous particles, which thus function as a framework for the composite particles. The fine electroactive structures are thought to have a lower resistance to elastic deformation and higher fracture resistance than larger electroactive structures, and are therefore able to lithiate and delithiate without excessive structural stress. As a result, the electroactive materials exhibit good reversible capacity retention over multiple charge-discharge cycles. Secondly, by controlling the loading of silicon within the porous carbon framework such that only part of the pore volume is occupied by silicon in the uncharged state, the unoccupied pore volume of the porous carbon framework is able to accommodate a substantial amount of silicon expansion internally. Excessive expansion is constrained by the particle framework. Furthermore, only a small area of the electroactive material surface is accessible to electrolyte and so SEI formation is substantially prevented.

In WO 2022/029422, the applicant has reported a further development in which control of the distribution of electroactive silicon within the pore network of the particle framework results in still a further improvement in the electrochemical performance of the composite particles. Specifically, the applicant has shown that electrochemical performance is optimised when the length scale of the individual silicon structures in the composite particles is minimised such that a large proportion of the silicon atoms are in a surface region of the silicon structures, with a relatively smaller proportion of silicon atoms located inside bulky/coarse silicon structures. The applicant has identified an optimised pore structure of the porous particle framework and a set of conditions for the deposition of silicon into the porous particle framework that allows for an increased proportion of this so-called “surface” silicon while also ensuring a large amount of silicon in total is incorporated into the composite particles to meet overall volumetric energy density requirements.

Efficient deposition of silicon in porous particles to achieve a commercially attractive balance of silicon content and residual surface area is challenging without accumulation of so-called coarse silicon. This is silicon which has a large characteristic length-scale due to being deposited into mesopores or on the outer surface of the porous particles. The silicon domain size can grow in an unbounded manner in this deposition regime. Coarse silicon can negatively affect the electrochemical performance of the composite particles.

It has now been found that additional modification of the composite particle structure after deposition of the silicon can provide a further improvement in the electrochemical performance of the composite particles.

### SUMMARY OF THE INVENTION

In a first aspect, the invention provides a process for preparing composite particles, the process comprising the steps of:
(a) providing a plurality of porous particles comprising micropores and/or mesopores;
(b) contacting the porous particles with a silicon-containing precursor at a temperature effective to cause deposition of a plurality of silicon domains in the pores of the porous particles;
(c) subjecting the particles from step (b) to heat treatment at a temperature of at least 400° C. and in the presence of an inert gas;
(d) contacting the particles from step (c) with a silicon-containing precursor at a temperature effective to cause deposition of further silicon domains in the pores of the porous particles.

The process of the invention involves the formation in step (b) of composite particles in which a plurality of silicon domains are deposited within the pore network of the porous particles by the thermal decomposition of a suitable precursor compound. The composite particles from step (b) are then subjected to a heat treatment in step (c).

Without being bound by theory, it is believed that silicon domains deposited in porous particles can occlude micropores and mesopores, resulting in encapsulated voids and preventing further deposition of silicon within the pores. This is thought to reduce the density of silicon in the composite particles and contribute to the formation of coarse silicon.

The silicon domains formed by thermal decomposition of a silicon-containing precursor are thought to be in the form of nanoclusters of silicon atoms that are substantially terminated by silicon-hydrogen bonds (Si—H). The heat treatment of the particles in step (c) is thought to promote the elimination of hydrogen and form molecular hydrogen (H₂). In the case that the silicon domains that are the direct result of step (b) do not comprise hydrogen atoms, the silicon domains may be reduced before step (c). Those skilled in the art are aware of suitable methods of reducing silicon domains. The heat treatment in step (c) may also cause elimination of terminal moieties other than hydrogen bonded to the silicon surface. The elimination of terminal moieties such as hydrogen is thought to cause the silicon domains to shrink, exposing additional pores that were previously occluded by deposited silicon. This increases the pore volume accessible to deposition of further silicon and thus increases the porosity of the particles.

The increased porosity of the particles after the heat treatment step is measurable. Porosity can be measured directly, for example by measuring the total volume of micropores and/or mesopores using nitrogen gas adsorption at 77 K down to a relative pressure p/p₀ of 10⁻⁶ using quenched solid density functional theory (QSDFT) in accordance with standard methodology as set out in ISO 15901-2 and ISO 15901-3. An increase in BET surface area of the particles after treatment also indicates that the porosity of the particles has increased.

Increasing the porosity of the particles enables further deposition of silicon. In step (d), the exposed pores are infiltrated with further silicon. The deposition of silicon domains in mesoporous and/or microporous particles is under a kinetic control regime that is selective to micropores and fine mesopores due to their relatively high surface area. This avoids the deposition of silicon outside the micropores and fine mesopores, resulting in improved structural control.

The process of the invention increases silicon loading of the composite particles to produce a highly densified composite with silicon preferentially located within the pores of the porous particle rather than on the particle surface or in large open accessible mesopores. In this way the structure and characteristic length scale of the silicon is better controlled.

The invention can therefore enable high composite density whilst maintaining a low value of coarse silicon.

In a second aspect, the invention provides a particulate material consisting of a plurality of composite particles obtainable by the process of the first aspect.

In a third aspect, the invention provides a composition comprising the particulate material of the second aspect and at least one other component.

In a fourth aspect, the invention provides an electrode comprising the particulate material of the second aspect or the composition of the third aspect.

In a fifth aspect, the invention provides a rechargeable metal-ion battery comprising the electrode of the fourth aspect.

### BRIEF DESCRIPTION OF DRAWINGS

FIG. 1 is a graph demonstrating the effect of heat treatment of step (c) according to the invention on the total volume of micropores and mesopores of composite particles obtained from chemical vapour infiltration of silicon into the pores of porous particles.

### DETAILED DESCRIPTION

The invention relates in general terms to a process for preparing composite particles in which thermal decomposition of a silicon-containing precursor is used to deposit a plurality of silicon domains into the pore network of microporous and/or mesoporous porous particles. The porous particles function as a framework for the silicon, which is typically deposited in the form of a plurality of silicon domains. As used herein, the term “silicon domain” refers to a body of elemental silicon having maximum dimensions that are determined by the location of the silicon within the micropores and/or mesopores of the porous particles. The silicon domains may be described as nanoscale silicon domains, wherein the term “nanoscale” is understood to refer generally to dimensions less than 100 nm. Although, due to the dimensions of micropores and mesopores, the silicon domains typically have maximum dimensions in any direction of less than 50 nm, and usually significantly less than 50 nm. A domain may for example take the form of a regular or irregular particle or a bounded layer or region of coating.

The porous particles generally comprise a three-dimensionally interconnected open pore network comprising micropores and/or mesopores and optionally a minor volume of macropores. In accordance with conventional IUPAC terminology, the term “micropore” is used herein to refer to pores of less than 2 nm in diameter, the term “mesopore” is used herein to refer to pores of 2-50 nm in diameter, and the term “macropore” is used to refer to pores of greater than 50 nm diameter.

References herein to the volume of micropores, mesopores and macropores in the porous particles, and also any references to the distribution of pore volume within the porous particles, relate to the internal pore volume of the porous particles used as the starting material in step (a) of the claimed process, i.e. prior to deposition of silicon into the pore volume in step (b).

The porous particles may be characterised by the total volume of micropores and mesopores (i.e. the total pore volume in the pore diameter range from 0 to 50 nm). Typically, the porous particles include both micropores and mesopores. However, it is not excluded that porous particles may be used which include micropores and no mesopores, or mesopores and no micropores.

The total volume of micropores and mesopores and the pore size distribution of micropores and mesopores are determined using nitrogen gas adsorption at 77 K down to a relative pressure p/p₀ of 10⁻⁶ using quenched solid density functional theory (QSDFT) in accordance with standard methodology as set out in ISO 15901-2 and ISO 15901-3. Nitrogen gas adsorption is a technique that characterises the porosity and pore diameter distributions of a material by allowing a gas to condense in the pores of a solid. As pressure increases, the gas condenses first in the pores of smallest diameter and the pressure is increased until a saturation point is reached at which all of the pores are filled with liquid. The nitrogen gas pressure is then reduced incrementally, to allow the liquid to evaporate from the system. Analysis of the adsorption and desorption isotherms, and the hysteresis between them, allows the pore volume and pore size distribution to be determined. Suitable instruments for the measurement of pore volume and pore size distributions by nitrogen gas adsorption include the TriStar II and TriStar II Plus porosity analyzers, which are available from Micromeritics Instrument Corporation, USA, and the Autosorb IQ porosity analyzers, which are available from Quantachrome Instruments.

Nitrogen gas adsorption is effective for the measurement of pore volume and pore size distributions for pores having a diameter up to 50 nm, but is less reliable for pores of much larger diameter. For the purposes of the present invention, nitrogen adsorption is therefore used to determine pore volumes and pore size distributions only for pores having a diameter up to and including 50 nm (i.e. only for micropores and mesopores). PD₅₀ values are likewise determined relative to the total volume of micropores and mesopores only.

In view of the limitations of available analytical techniques it is not possible to measure pore volumes and pore size distributions across the entire range of micropores, mesopores and macropores using a single technique. In the case that the porous particles comprise macropores, the volume of pores having diameter in the range from greater than 50 nm and up to 100 nm may be measured by mercury porosimetry and is preferably no more than 0.3 cm³/g, or no more than 0.2 cm³/g, or no more than 0.1 cm³/g, or no more than 0.05 cm³/g.

A small fraction of macropores may be useful to facilitate electrolyte access into the pore network, but the advantages of the invention are obtained substantially by accommodating electroactive material in micropores and smaller mesopores. Any pore volume measured by mercury porosimetry at pore sizes of 50 nm or below is disregarded (as set out above, nitrogen adsorption is used to characterize the mesopores and micropores). Pore volume measured by mercury porosimetry above 100 nm is assumed for the purposes of the invention to be inter-particle porosity and is also disregarded.

Mercury porosimetry is a technique that characterizes the porosity and pore diameter distributions of a material by applying varying levels of pressure to a sample of the material immersed in mercury. The pressure required to intrude mercury into the pores of the sample is inversely proportional to the size of the pores. Values obtained by mercury porosimetry as reported herein are obtained in accordance with ASTM UOP578-11, with the surface tension y taken to be 480 mN/m and the contact angle φ taken to be 140° for mercury at room temperature. The density of mercury is taken to be 13.5462 g/cm³ at room temperature. A number of high precision mercury porosimetry instruments are commercially available, such as the AutoPore IV series of automated mercury porosimeters available from Micromeritics Instrument Corporation, USA. For a complete review of mercury porosimetry reference may be made to P. A. Webb and C. Orr in “Analytical Methods in Fine Particle Technology, 1997, Micromeritics Instrument Corporation, ISBN 0-9656783-0.

It will be appreciated that intrusion techniques such as gas adsorption and mercury porosimetry are effective only to determine the pore volume of pores that are accessible to nitrogen or to mercury from the exterior of the porous particles. Porosity values specified herein shall be understood as referring to the volume of open pores, i.e. pores that are accessible to a fluid from the exterior of the porous particles. Fully enclosed pores which cannot be identified by nitrogen adsorption or mercury porosimetry shall not be taken into account herein when determining porosity values. Likewise, any pore volume located in pores that are so small as to be below the limit of detection by nitrogen adsorption is not taken into account.

The total pore volume of micropores and mesopores in the porous particles as measured by gas adsorption may be at least 0.4 cm³/g. The total pore volume of micropores and mesopores in the porous particles as measured by gas adsorption may be at least 0.5 cm³/g, or at least 0.6 cm³/g, or at least 0.65 cm³/g, or at least 0.7 cm³/g, or at least 0.75 cm³/g, or at least 0.8 cm³/g. The use of higher porosity particles may be advantageous since it allows a larger amount of electroactive material to be accommodated within the pore volume.

The internal pore volume of the porous particles is suitably capped at a value at which increasing fragility of the particles structure outweighs the advantage of increased pore volume accommodating a larger amount of electroactive material. The total pore volume of micropores and mesopores in the porous particles as measured by gas adsorption may be no more than 2 cm³/g, or no more than 1.8 cm³/g, or no more than 1.7 cm³/g, or no more than 1.6 cm³/g, or no more than 1.55 cm³/g, or no more than 1.5 cm³/g, or no more than 1.45 cm³/g, or no more than 1.4 cm³/g, or no more than 1.35 cm³/g, or no more than 1.3 cm³/g, or no more than 1.25 cm³/g, or no more than 1.2 cm³/g.

The total pore volume of micropores and mesopores in the porous particles as measured by gas adsorption may be in the range from 0.4 to 2 cm³/g, or from 0.4 to 1.8 cm³/g, or from 0.4 to 1.7 cm³/g, or from 0.5 to 1.6 cm³/g, or from 0.5 to 1.55 cm³/g, or from 0.6 to 1.5 cm³/g, or from 0.6 to 1.45 cm³/g, or from 0.65 to 1.4 cm³/g, or from 0.65 to 1.35 cm³/g, or from 0.7 to 1.3 cm³/g, or from 0.7 to 1.25 cm³/g, or from 0.75 to 1.2 cm³/g, or from 0.75 to 1.1 cm³/g, or from 0.8 to 1.2 cm³/g, or from 0.8 to 1.1 cm³/g.

The general term “PDₙ pore diameter” refers herein to the volume-based nth percentile pore diameter, based on the total volume of micropores and mesopores. For instance, the term “PD₅₀ pore diameter” as used herein refers to the pore diameter below which 50% of the total micropore and mesopore volume is found. For the avoidance of doubt, any macropore volume (pore diameter greater than 50 nm) is not taken into account for the purpose of determining PDₙ values.

The PD₉₀ pore diameter of the porous particles may be no more than 30 nm, or no more than 25 nm, or no more than 20 nm, or no more than 15 nm, or no more than 12 nm, or no more than 10 nm, or no more than 8 nm, or no more than 6 nm, or no more than 5 nm.

The PD₉₀ pore diameter of the porous particles may be at least 3.2 nm, or at least 3.5 nm, or at least 3.8 nm, or at least 4 nm.

The PD₉₀ pore diameter of the porous particles may be in the range from 3.2 to 30 nm, or from 3.5 to 25 nm, or from 3.8 to 20 nm, or from 4 to 8 nm.

The PD₅₀ pore diameter of the porous particles may be no more than 20 nm, or no more than 15 nm, or no more than 12 nm, or no more than 10 nm, or no more than 8 nm, or no more than 6 nm, or no more than 5 nm, or no more than 4 nm, or no more than 3 nm, or no more than 2.5 nm, or no more than 2 nm, or no more than 1.5 nm.

The volume fraction of micropores based on the total volume of micropores and mesopores in the porous particles may be at least 0.4, or at least 0.45, or at least 0.5, or at least 0.55, or at least 0.6, or at least 0.65, or at least 0.7.

The total pore volume of micropores and mesopores in the composite particles formed in the final step (d) as measured by gas adsorption may be no more than 0.6 cm³/g, or no more than 0.5 cm³/g, or no more than 0.4 cm³/g, or no more than 0.3 cm³/g, or no more than 0.2 cm³/g, or no more than 0.1 cm³/g.

The total pore volume of micropores and mesopores in the composite particles formed in the final step (d) as measured by gas adsorption may be at least 0.01 cm³/g.

The pore size distribution of the porous particles may be monomodal, bimodal or multimodal. As used herein, the term “pore size distribution” relates to the distribution of pore size relative to the cumulative total internal pore volume of the porous particles. A bimodal or multimodal pore size distribution may be preferred since close proximity between micropores and pores of larger diameter provides the advantage of efficient ionic transport through the porous network to the electroactive material.

The term “particle diameter” as used herein refers to the equivalent spherical diameter (esd), i.e. the diameter of a sphere having the same volume as a given particle, wherein the particle volume is understood to include the volume of any intra-particle pores. The terms “D₅₀” and “D₅₀ particle diameter” as used herein refer to the volume-based median particle diameter, i.e. the diameter below which 50% by volume of the particle population is found. The terms “D₁₀” and “D₁₀ particle diameter” as used herein refer to the 10th percentile volume-based median particle diameter, i.e. the diameter below which 10% by volume of the particle population is found. The terms “D₉₀” and “D₉₀ particle diameter” as used herein refer to the 90th percentile volume-based median particle diameter, i.e. the diameter below which 90% by volume of the particle population is found.

Particle diameters and particle size distributions can be determined by standard laser diffraction techniques in accordance with ISO 13320:2009. Laser diffraction relies on the principle that a particle will scatter light at an angle that varies depending on the size the particle and a collection of particles will produce a pattern of scattered light defined by intensity and angle that can be correlated to a particle size distribution. A number of laser diffraction instruments are commercially available for the rapid and reliable determination of particle size distributions. Unless stated otherwise, particle size distribution measurements as specified or reported herein are as measured by the conventional Malvern Mastersizer™ 3000 particle size analyzer from Malvern Instruments™ The Malvern Mastersizer™ 3000 particle size analyzer operates by projecting a helium-neon gas laser beam through a transparent cell containing the particles of interest suspended in an aqueous solution. Light rays which strike the particles are scattered through angles which are inversely proportional to the particle size and a photodetector array measures the intensity of light at several predetermined angles and the measured intensities at different angles are processed by a computer using standard theoretical principles to determine the particle size distribution. Laser diffraction values as reported herein are obtained using a wet dispersion of the particles in 2-propanol with a 5 vol % addition of the surfactant SPAN™-40 (sorbitan monopalmitate). The particle refractive index is taken to be 2.68 for porous particles and 3.50 for composite particles and the dispersant index is taken to be 1.378. Particle size distributions are calculated using the Mie scattering model.

The porous particles may have a D₅₀ particle diameter in the range from 1 to 30 μm. Optionally, the D₅₀ particle diameter of the porous particles may be at least 1 μm, or at least 1.5 μm, or at least 2 μm, or at least 2.5 μm, or at least 3 μm, or at least 4 μm, or at least 5 μm. Optionally the D₅₀ particle diameter of the porous particles may be no more than 25 μm, or no more than 20 μm, or no more than 18 μm, or no more than 15 μm, or no more than 12 μm, or no more than 10 μm, or no more than 8 μm.

The D₁₀ particle diameter of the porous particles is preferably at least 0.5 μm, or at least 0.8 μm, or at least 1 μm, or at least 1.5 μm, or at least 2 μm. By maintaining the D₁₀ particle diameter at 0.5 μm or more, the potential for undesirable agglomeration of sub-micron sized particles is reduced, and improved dispersibility of the composite particles formed.

The D₉₀ particle diameter of the porous particles is preferably no more than 50 μm, or no more than 40 μm, or no more than 30 μm, or no more than 25 μm, or no more than 20 μm, or no more than 15 μm.

The porous particles preferably have a narrow size distribution span. For instance, the particle size distribution span (defined as (D₉₀−D₁₀)/D₅₀) is preferably 5 or less, more preferably 4 or less, more preferably 3 or less, more preferably 2 or less, and most preferably 1.5 or less. By maintaining a narrow size distribution span, efficient packing of the particles into dense powder beds is more readily achievable.

The composite particles formed in the final step (d) may have a D₅₀ particle diameter in the range of 1 to 30 μm.

The composite particles formed in the final step (d) may have a D₁₀ particle diameter of at least 0.5 μm, or at least 0.8 μm, or at least 1 μm, or at least 1.5 μm, or at least 2 μm.

The composite particles formed in the final step (d) may have a Do particle diameter of no more than 50 μm, or no more than 40 μm, or no more than 30 μm, or no more than 25 μm, or no more than 20 μm, or no more than 15 μm.

It is possible to obtain highly accurate two-dimensional projections of micron scale particles by scanning electron microscopy (SEM) or by dynamic image analysis, in which a digital camera is used to record the shadow projected by a particle. The term “sphericity” as used herein shall be understood as the ratio of the area of the particle projection (obtained from such imaging techniques) to the area of a circle, wherein the particle projection and circle have identical circumference. Thus, for an individual particle, the sphericity S may be defined as:

$$S = \frac{4 \cdot π \cdot {A}_{m}}{{( {C}_{m} )}^{2}}$$

wherein Aₘ is the measured area of the particle projection and Cₘ is the measured circumference of the particle projection. The average sphericity Sₐᵥ of a population of particles as used herein is defined as:

$${S}_{a ν} = \frac{1}{n} {\sum }_{i = 1}^{n} [ \frac{4 \cdot π \cdot {A}_{m}}{{( {C}_{m} )}^{2}} ]$$

wherein n represents the number of particles in the population. The average sphericity for a population of particles is preferably calculated from the two-dimensional projections of at least 50 particles.

The porous particles may have an average sphericity (as defined herein) of more than 0.5. Preferably they have an average sphericity of at least 0.55, or at least 0.6, or at least 0.65, or at least 0.7, or at least 0.75, or at least 0.8, or at least 0.85. Preferably, the porous particles have an average sphericity of at least 0.90, or at least 0.92, or at least 0.93, or at least 0.94, or at least 0.95. Spherical particles are believed to aid uniformity of deposition and facilitate denser packing both in the batch pressure reactor and of the final product when incorporated into electrodes.

The term “BET surface area” as used herein should be taken to refer to the surface area per unit mass calculated from a measurement of the physical adsorption of gas molecules on a solid surface, using the Brunauer-Emmett-Teller theory, in accordance with ISO 9277.

The porous particles may have a BET surface area in the range from 100 m²/g to 4,000 m²/g, or from 500 m²/g to 4,000 m²/g, or from 750 m²/g to 3,500 m²/g, or from 1,000 m²/g to 3,250 m²/g, or from 1,000 m²/g to 3,000 m²/g, or from 1,000 m²/g to 2,500 m²/g, or from 1,000 m²/g to 2,000 m²/g.

The composite particles formed in step (c) may have a BET surface area that is at least 30 m²/g, or at least 40 m²/g, or at least 50 m²/g, or at least 60 m²/g, or at least 70 m²/g, or at least 80 m²/g, or at least 90 m²/g, or at least 100 m²/g greater than the BET surface area of the composite particles formed in step (b).

The composite particles formed in the final step (d) may have a BET surface area in the range from 0.1 to 100 m²/g, or from 0.1 to 80 m²/g, or from 0.5 to 60 m²/g, or from 0.5 to 40 m²/g, or from 1 to 30 m²/g, or from 1 to 25 m²/g, or from 2 to 20 m²/g. In general, a low BET surface area is preferred in order to minimize the formation of solid electrolyte interphase (SEI) layers at the surface of the composite particles during the first charge-discharge cycle of an anode. However, a BET surface area which is excessively low results in unacceptably low charging rate and capacity due to the inaccessibility of the bulk of the electroactive material to metal ions in the surrounding electrolyte.

As used herein, the term “particle density” refers to “apparent particle density” as measured by mercury porosimetry (i.e. the mass of a particle divided by the particle volume wherein the particle volume is taken to be the sum of the volume of solid material and any closed or blind pores (a “blind pore” is pore that is too small to be measured by mercury porosimetry). The porous particles preferably have a particle density of at least 0.35 and preferably less than 3 g/cm³, more preferably less than 2 g/cm³, more preferably less than 1.5 g/cm³, most preferably from 0.35 to 1.2 g/cm³. Preferably, the porous particles have particle density of at least 0.4 g/cm³, or at least 0.45 g/cm³, or at least 0.5 g/cm³, or at least 0.55 g/cm³, or at least 0.6 g/cm³, or at least 0.65 g/cm³, or at least 0.7 g/cm³. Preferably, the porous particles have particle density of no more than 1.15 g/cm³, or no more than 1.1 g/cm³, or no more than 1.05 g/cm³, or no more than 1 g/cm³, or no more than 0.95 g/cm³, or no more than 0.9 g/cm³.

The porous particles may have:
(i) a total pore volume of micropores and mesopores as measured by nitrogen gas adsorption in the range from 0.4 to 1.8 cm³/g;
(ii) a PD₅₀ pore diameter of no more than 10 nm, and preferably a PD₉₀ pore diameter of no more than 20 nm; and
(iii) a D₅₀ particle diameter in the range from 1 to 30 μm.

The porous particles may have:
(i) a total pore volume of micropores and mesopores as measured by nitrogen gas adsorption in the range from 0.5 to 1.6 cm³/g;
(ii) a PD₅₀ pore diameter of no more than 8 nm, and preferably a PD₉₀ pore diameter of no more than 15 nm; and
(iii) a D₅₀ particle diameter in the range from 1 to 25 μm.

The porous particles may have:
(i) a total pore volume of micropores and mesopores as measured by nitrogen gas adsorption in the range from 0.6 to 1.5 cm³/g;
(ii) a PD₅₀ pore diameter of no more than 6 nm, and preferably a PD₉₀ pore diameter of no more than 12 nm; and
(iii) a D₅₀ particle diameter in the range from 1.5 to 20 μm.

The porous particles may have:
(i) a total pore volume of micropores and mesopores as measured by nitrogen gas adsorption in the range from 0.65 to 1.4 cm³/g;
(ii) a PD₅₀ pore diameter of no more than 2.5 nm, and preferably a PD₉₀ pore diameter of no more than 10 nm; and
(iii) a D₅₀ particle diameter in the range from 1.5 to 18 μm.

The porous particles may have:
(i) a total pore volume of micropores and mesopores as measured by nitrogen gas adsorption in the range from 0.7 to 1.3 cm³/g;
(ii) a PD₅₀ pore diameter of no more than 4 nm, and preferably a PD₉₀ pore diameter of no more than 8 nm; and
(iii) a D₅₀ particle diameter in the range from 2 to 15 μm.

The porous particles may have:
(i) a total pore volume of micropores and mesopores as measured by nitrogen gas adsorption in the range from 0.75 to 1.2 cm³/g;
(ii) a PD₅₀ pore diameter of no more than 3 nm, and preferably a PD₉₀ pore diameter of no more than 6 nm; and
(iii) a D₅₀ particle diameter in the range from 2 to 12 μm.

The porous particles may have:
(i) a total pore volume of micropores and mesopores as measured by nitrogen gas adsorption in the range from 0.8 to 1.2 cm³/g;
(ii) a PD₅₀ pore diameter of no more than 2 nm, and preferably a PD₉₀ pore diameter of no more than 5 nm; and
(iii) a D₅₀ particle diameter in the range from 2.5 to 10 μm.

The porous particles may be conductive porous particles. The porous particles may be conductive porous carbon particles. The use of conductive porous particles is advantageous as the porous particles form a conductive framework within the composite particles which facilitates the flow of electrons between lithium atoms/ions inserted into the electroactive material and a current collector.

The conductive porous carbon particles may comprise at least 80 wt % carbon, or at least 85 wt % carbon, or at least 90 wt % carbon, or at least 95 wt % carbon. The carbon may be crystalline carbon or amorphous carbon, or a mixture of amorphous and crystalline carbon. The conductive porous carbon particles may be either hard carbon particles or soft carbon particles.

As used herein, the term “hard carbon” refers to a disordered carbon matrix in which carbon atoms are found predominantly in the sp² hybridised state (trigonal bonds) in nanoscale polyaromatic domains. The polyaromatic domains are cross-linked with a chemical bond, e.g. a C—O—C bond. Due to the chemical cross-linking between the polyaromatic domains, hard carbons cannot be converted to graphite at high temperatures. Hard carbons have graphite-like character as evidenced by the large G-band (˜1600 cm⁻¹) in the Raman spectrum. However, the carbon is not fully graphitic as evidenced by the significant D-band (˜1350 cm⁻¹) in the Raman spectrum.

As used herein, the term “soft carbon” also refers to a disordered carbon matrix in which carbon atoms are found predominantly in the sp² hybridised state (trigonal bonds) in polyaromatic domains having dimensions in the range from 5 to 200 nm. In contrast to hard carbons, the polyaromatic domains in soft carbons are associated by intermolecular forces but are not cross-linked with a chemical bond. This means that they will graphitise at high temperature. The porous carbon particles preferably comprise at least 50% sp² hybridised carbon as measured by XPS. For example, the porous carbon particles may suitably comprise from 50% to 98% sp² hybridised carbon, from 55% to 95% sp² hybridised carbon, from 60% to 90% sp² hybridised carbon, or from 70% to 85% sp² hybridised carbon.

A variety of different materials may be used to prepare suitable porous carbon particles via pyrolysis. Examples of organic materials that may be used include plant biomass including lignocellulosic materials (such as coconut shells, rice husks, wood etc.) and fossil carbon sources such as coal. Examples of resins and polymeric materials which form porous carbon particles on pyrolysis include phenolic resins, novolac resins, pitch, melamines, polyacrylates, polystyrenes, polyvinylalcohol (PVA), polyvinylpyrrolidone (PVP), and various copolymers comprising monomer units of acrylates, styrenes, α-olefins, vinyl pyrrolidone and other ethylenically unsaturated monomers. A variety of different carbon materials are available in the art depending on the starting material and the conditions of the pyrolysis process. Porous carbon particles of various different specifications are available from commercial suppliers.

Porous carbon particles may undergo a chemical or gaseous activation process to increase the volume of mesopores and micropores. A suitable activation process comprises contacting pyrolyzed carbon with one or more of oxygen, steam, CO, CO₂ and KOH at a temperature in the range from 600 to 1000° C.

Mesopores can also be obtained by known templating processes, using extractable pore formers such as MgO and other colloidal or polymer templates which can be removed by thermal or chemical means post pyrolysis or activation.

Alternatives to carbon-based conductive particles include porous particles comprising titanium nitride (TiN), titanium carbide (TIC), silicon carbide (SiC), nickel oxide (NiOx), titanium silicon nitride (TiSiN), nickel nitride (Ni₃N), molybdenum nitride (MoN), titanium oxynitride (TiOₓN₁₋ₓ), silicon oxycarbide (SiOC), boron nitride (BN), or vanadium nitride (VN). Preferably the porous particles comprise titanium nitride (TiN), silicon oxycarbide (SiOC) or boron nitride (BN).

The composite particles of the invention are suitably prepared via chemical vapor infiltration (CVI) of a silicon-containing precursor into the pore structure of the porous particles. As used herein, CVI refers to processes in which a silicon-containing precursor is thermally decomposed on a surface to form elemental silicon at the surface and by-products.

The silicon-containing precursor may be a gaseous silicon-containing precursor. The gaseous silicon-containing precursor in steps (b) and/or (d) may be used either in pure form (or substantially pure form) or as a diluted mixture with an inert carrier gas, such as nitrogen or argon. The gaseous silicon-containing precursor in step (b) and/or (d) may independently comprise at least 30 vol %, or at least 40 vol %, or at least 50 vol %, or at least 60 vol %, or at least 70 vol %, or at least 80 vol %, or at least 90 vol %, or at least 95 vol %, or at least 97 vol %, or at least 99 vol % of the silicon-containing precursor based on the total volume of the gas.

The silicon-containing precursor in step (b) and/or (d) may be independently selected from the group consisting of silane (SiH₄), disilane (Si₂H₆), trisilane (Si₃H₈), tetrasilane (Si₄H₁₀), methylsilane, dimethylsilane and chlorosilanes, preferably selected from the group consisting of silane (SiH₄), disilane (Si₂H₆), trisilane (Si₃H₈) and tetrasilane (Si₄H₁₀). A particularly preferred precursor of silicon is silane.

In the case that the precursor is a chlorinated compound, such as a chlorosilane, the precursor is preferably used in admixture with hydrogen gas, preferably in at least a 1:1 atomic ratio of hydrogen to chlorine.

Optionally, the precursor is free of chlorine. Free of chlorine means that the precursor contains less than 1 wt %, preferably less than 0.1 wt %, preferably less than 0.01 wt % of chlorine-containing compounds.

The presence of oxygen in steps (b) and (d) should be avoided to prevent undesired oxidation of the deposited silicon, in accordance with conventional procedures for working in an inert atmosphere. Preferably, the oxygen content is less than 0.01 vol %, more preferably less than 0.001 vol % based on the total volume of gas used in step (b) or (d).

Steps (b) and/or (d) may be independently carried out at a temperature in the range from 340 to 500° C., or from 350 to 480° C., or from 350 to 450° C., or from 350 to 420° C., or from 350 to less than 400° C., or from 355 to 395° C., or from 360 to 390° C., or from 360 to 385° C., or from 360 to 380° C. Preferably, steps (b) and/or (d) are independently carried out at a temperature in the range from 340 to less than 400° C., or from 370 to 395° C.

Steps (b) and/or (d) may be independently carried out at a pressure in the range from 1 to 10000 kPa, or from 10 to 6000 kPa, or from 20 to 4000 kPa, or from 50 to 2000 kPa, or from 80 to 1500 kPa, or from 90 to 1000 kPa, or from 90 to 600 kPa or about 100 kPa.

References to the pressure in any step of the claimed process refer to the absolute pressure in the reaction zone, which may comprise any suitable form of reactor vessel.

The deposition of silicon by CVI results in the elimination of by-products, particularly by-product gases such as hydrogen. Step (b) preferably further comprises the separation of by-products from the particles formed in step (b). Separation of by-products may be effected by flushing the reactor with an inert gas and/or by evacuating the reactor by reducing the pressure. For example, the separation of by-products from the particles formed in step (b) may be effected by evacuating the reactor to a pressure of less than 100 kPa, or less than 80 kPa, or less than 60 kPa, or less than 40 kPa, or less than 20 kPa, or less than 10 kPa, or less than 5 kPa, or less than 2 kPa, or less than 1 kPa. Evacuating the reactor to low pressure may be effective not only to remove by-products in the gas phase, but also to desorb any by-products that may be adsorbed onto the surfaces of the deposited silicon.

The ratio of BET surface area of the particles formed in step (c) to BET surface area of the particles formed in step (b) may be at least 1.1:1, or at least 1.2:1, or at least 1.3:1, or at least 1.4:1, or at least 1.5:1, or at least 2:1, or at least 3:1, or at least 4:1, or at least 5:1.

The ratio of BET surface area of the particles formed in step (c) to BET surface area of the particles formed in step (b) may be no more than 15:1, or no more than 14:1, or no more than 13:1, or no more than 12:1.

The ratio of total pore volume of micropores and mesopores as measured by gas adsorption of the particles formed in step (c) to total pore volume of micropores and mesopores as measured by gas adsorption of the particles formed in step (b) may be at least 2:1, or at least 3:1, or at least 4:1, or at least 5:1, or at least 6:1, or at least 7:1, or at least 8:1.

The ratio of total pore volume of micropores and mesopores as measured by gas adsorption of the particles formed in step (c) to total pore volume of micropores and mesopores as measured by gas adsorption of the particles formed in step (b) may be no more than 20:1, or no more than 19:1, or no more than 18:1, or no more than 17:1, or no more than 16:1, or no more than 15:1.

The ratio of total hydrogen content of the particles formed in step (c) to total hydrogen content of the particles formed in step (b) may be no more than 0.8:1, or no more than 0.7:1, or no more than 0.6:1, or no more than 0.5:1.

The ratio of total hydrogen content of the particles formed in step (c) to total hydrogen content of the particles formed in step (b) may be at least 0.1:1, or at least 0.2:1, or at least 0.3:1.

The temperature in step (c) may be greater than the temperature in step (b). The temperature in step (c) may be at least 20° C., or at least 40° C., or at least 60° C., or at least 80° C., or at least 100° C., or at least 120° C., or at least 140° C., or at least 150° C. greater than the temperature in step (b).

The temperature in step (c) may be at least 450° C., or at least 500° C., or at least 510° C., or at least 520° C., or at least 540° C., or at least 560° C., or at least 580° C., or at least 600° C., or at least 610° C., or at least 620° C., or at least 630° C., or at least 640° C., or at least 650° C. Preferably, the temperature in step (c) is at least 500° C. More preferably, the temperature in step (c) is at least 510° C. More preferably, the temperature in step (c) is at least 520° C. The temperature in step (c) may be no more than 900° C., or no more than 850° C., or no more than 800° C., or no more than 750° C., or no more than 700° C., or no more than 680° C., or no more than 660° C., or no more than 650° C. Preferably, the temperature in step (c) is no more than 750° C. More preferably, the temperature in step (c) is no more than 700° C.

The temperature in step (c) may be in the range from 400° C. to 900° C., or from 500° C. to 900° C., or from 600° C. to 900° C. The temperature in step (c) may be in the range from 500° C. to 800° C., or from 510° C. to 800° C., or from 520° C. to 750° C., or from 540° C. to 700° C., or from 560° C. to 680° C., or from 580° C. to 660° C., or from 600° C. to 650° C. Preferably, the temperature in step (c) is in the range from 500° C. to 750° C. More preferably, the temperature in step (c) is in the range from 510° C. to 750° C. More preferably, the temperature in step (c) is in the range or from 520° C. to 700° C.

The duration of step (c) is preferably at least 1 minute, or at least 2 minutes, or at least 5 minutes, or at least 10 minutes, or at least 15 minutes, or at least 20 minutes, or at least 30 minutes, or at least 45 minutes, or at least 1 hour, or at least 2 hours. Preferably, step (c) is carried out for a period of at least 30 minutes. More preferably, step (c) is carried out for a period of at least 1 hour. More preferably, step (c) is carried out for a period of at least 90 minutes. Preferably, the duration of step (c) is no more than 72 hours, or no more than 48 hours, or no more than 24 hours, or no more than 12 hours, or no more than 6 hours, or no more than 5 hours, or no more than 4 hours, or no more than 3 hours. Preferably, step (c) is carried out for a period of no more than 24 hours. More preferably, step (c) is carried out for a period of no more than 12 hours. More preferably, step (c) is carried out for a period of no more than 6 hours.

The duration of step (c) may be in the range from 1 minute to 72 hours, or from 2 minutes to 48 hours, or from 5 minutes to 24 hours, or from 10 minutes to 12 hours, or from 15 minutes to 6 hours, or from 20 minutes to 5 hours, or from 30 minutes to 4 hours, or from 1 hour to 4 hours, or from 1 hour to 3 hours. Preferably, the duration of step (c) is in the range from 30 minutes to 24 hours. More preferably, the duration of step (c) is in the range from 1 hour to 12 hours. More preferably, the duration of step (c) is in the range from 90 minutes to 6 hours.

Step (c) preferably comprises maintaining the particles from step (b) above a lower threshold temperature TL of at least 400° C. for a time period t. More preferably, step (c) comprises maintaining the particles from step (b) between the lower threshold temperature TL and an upper threshold temperature TU for the time period t.

The lower threshold temperature TL in step (c) may be 450° C., or 500° C., or 510° C., or 520° C., or 540° C., or 560° C., or 580° C., or 600° C., or 610° C., or 620° C., or 630° C., or 640° C., or 650° C. Preferably, the lower threshold temperature TL in step (c) is 500° C. More preferably, the lower threshold temperature TL in step (c) is 510° C. More preferably, the lower threshold temperature TL in step (c) is 520° C. Preferably, the upper threshold temperature TU in step (c) is 900° C., or 850° C., or 800° C., or 750° C., or 700° C., or 695° C., or 680° C., or 660° C., or 650° C. More preferably, the upper threshold temperature TU in step (c) is 750° C. More preferably, the upper threshold temperature TU in step (c) is 700° C.

The lower threshold temperature TL and the upper threshold temperature TU may respectively be 400° C. and 900° C., or 500° C. and 900° C., or 600° C. and 900° C. The lower threshold temperature TL and the upper threshold temperature TU may respectively be 500° C. and 800° C., or 510° C. and 800° C., or 520° C. and 750° C., or 540° C. and 700° C., or 560° C. and 680° C., or 580° C. and 660° C., or 600° C. and 650° C. Preferably, the lower threshold temperature TL and the upper threshold temperature TU are respectively 500° C. and 750° C. More preferably, the lower threshold temperature TL and the upper threshold temperature TU are respectively 510° C. and 750° C. More preferably, the lower threshold temperature TL and the upper threshold temperature TU are respectively 520° C. and 700° C.

The time period t is preferably at least 1 minute, or at least 2 minutes, or at least 5 minutes, or at least 10 minutes, or at least 15 minutes, or at least 20 minutes, or at least 30 minutes, or at least 45 minutes, or at least 1 hour, or at least 2 hours. More preferably, the time period t is at least 30 minutes. More preferably, the time period t is at least 1 hour. More preferably, the time period tis at least 90 minutes. Preferably, the time period t is no more than 72 hours, or no more than 48 hours, or no more than 24 hours, or no more than 12 hours, or no more than 6 hours, or no more than 5 hours, or no more than 4 hours, or no more than 3 hours. More preferably, the time period t is no more than 24 hours. More preferably, the time period t is no more than 12 hours. More preferably, the time period t is no more than 6 hours.

The time period t may be in the range from 1 minute to 72 hours, or from 2 minutes to 48 hours, or from 5 minutes to 24 hours, or from 10 minutes to 12 hours, or from 15 minutes to 6 hours, or from 20 minutes to 5 hours, or from 30 minutes to 4 hours, or from 1 hour to 4 hours, or from 1 hour to 3 hours. Preferably, the time period t is in the range from 30 minutes to 24 hours. More preferably, the time period t is in the range from 1 hour to 12 hours. More preferably, the time period t is in the range from 90 minutes to 6 hours.

Step (c) is carried out in the presence of an inert gas. An inert gas refers herein to any gas that does not undergo reaction under the conditions of step (c). Accordingly, gases that undergo reaction under the conditions of step (c) are not present during step (c). Preferably, the inert gas is selected from nitrogen and the noble gases, in particular argon. Optionally, the inert gas may comprise hydrogen. The inert gas may be selected from the group consisting of nitrogen, argon, helium and combinations thereof. Step (c) may be carried out in the presence of hydrogen and a gas selected from the group consisting of nitrogen, argon, helium and combinations thereof.

Preferably, step (c) is carried out:
(i) At a temperature in the range from 400° C. to 900° C.;
(ii) For a period of from 1 minute to 72 hours; and
(iii) In the presence of an inert gas, optionally comprising hydrogen.

Preferably, step (c) is carried out:

(i) At a temperature in the range from 500° C. to 900° C.;

(ii) For a period of from 30 minutes to 4 hours; and

(iii) In the presence of an inert gas, optionally comprising hydrogen.

Preferably, step (c) is carried out:
(i) At a temperature in the range from 600° C. to 900° C.;
(ii) For a period of from 1 hour to 4 hours; and
(iii) In the presence of an inert gas, optionally comprising hydrogen.

Preferably, step (c) is carried out:
(i) At a temperature in the range from 500° C. to 750° C.;
(ii) For a period of from 30 minutes to 24 hours; and
(iii) In the presence of an inert gas, optionally comprising hydrogen.

Preferably, step (c) is carried out:
(i) At a temperature in the range from 500° C. to 750° C.;
(ii) For a period of from 1 hour to 12 hours; and
(iii) In the presence of an inert gas, optionally comprising hydrogen.

Preferably, step (c) is carried out:
(i) At a temperature in the range from 500° C. to 700° C.;
(ii) For a period of from 90 minutes to 6 hours; and
(iii) In the presence of an inert gas, optionally comprising hydrogen.

Preferably, step (c) is carried out:
(i) At a temperature in the range from 510° C. to 750° C.;
(ii) For a period of from 30 minutes to 24 hours; and
(iii) In the presence of an inert gas, optionally comprising hydrogen.

Preferably, step (c) is carried out:
(i) At a temperature in the range from 510° C. to 750° C.;
(ii) For a period of from 1 hour to 12 hours; and
(iii) In the presence of an inert gas, optionally comprising hydrogen.

Preferably, step (c) is carried out:
(i) At a temperature in the range from 510° C. to 700° C.;
(ii) For a period of from 90 minutes to 6 hours; and
(iii) In the presence of an inert gas, optionally comprising hydrogen.

Preferably, step (c) is carried out:
(i) At a temperature in the range from 520° C. to 750° C.;
(ii) For a period of from 30 minutes to 24 hours; and
(iii) In the presence of an inert gas, optionally comprising hydrogen.

Preferably, step (c) is carried out:
(i) At a temperature in the range from 520° C. to 750° C.;
(ii) For a period of from 1 hour to 12 hours; and
(iii) In the presence of an inert gas, optionally comprising hydrogen.

Preferably, step (c) is carried out:
(i) At a temperature in the range from 520° C. to 700° C.;
(ii) For a period of from 90 minutes to 6 hours; and
(iii) In the presence of an inert gas, optionally comprising hydrogen.

Preferably, step (c) is carried out:
(i) With a lower threshold temperature TL of 500° C. and an upper threshold temperature TU of 750° C.;
(ii) For a time period t of from 30 minutes to 24 hours; and
(iii) In the presence of an inert gas, optionally comprising hydrogen.

Preferably, step (c) is carried out:
(i) With a lower threshold temperature TL of 500° C. and an upper threshold temperature TU of 750° C.;
(ii) For a time period t of from 1 hour to 12 hours; and
(iii) In the presence of an inert gas, optionally comprising hydrogen.

Preferably, step (c) is carried out:
(i) With a lower threshold temperature TL of 500° C. and an upper threshold temperature TU of 700° C.;
(ii) For a time period t of from 90 minutes to 6 hours; and
(iii) In the presence of an inert gas, optionally comprising hydrogen.

Preferably, step (c) is carried out:

(i) With a lower threshold temperature TL of 510° C. and an upper threshold temperature TU of 750° C.;

(ii) For a time period t of from 30 minutes to 24 hours; and

(iii) In the presence of an inert gas, optionally comprising hydrogen.

Preferably, step (c) is carried out:
(i) With a lower threshold temperature TL of 510° C. and an upper threshold temperature TU of 750° C.;
(ii) For a time period t of from 1 hour to 12 hours; and
(iii) In the presence of an inert gas, optionally comprising hydrogen.

Preferably, step (c) is carried out:
(i) With a lower threshold temperature TL of 510° C. and an upper threshold temperature TU of 700° C.;
(ii) For a time period t of from 90 minutes to 6 hours; and
(iii) In the presence of an inert gas, optionally comprising hydrogen.

Preferably, step (c) is carried out:
(i) With a lower threshold temperature TL of 520° C. and an upper threshold temperature TU of 750° C.;
(ii) For a time period t of from 30 minutes to 24 hours; and
(iii) In the presence of an inert gas, optionally comprising hydrogen.

Preferably, step (c) is carried out:
(i) With a lower threshold temperature TL of 520° C. and an upper threshold temperature TU of 750° C.;
(ii) For a time period t of from 1 hour to 12 hours; and
(iii) In the presence of an inert gas, optionally comprising hydrogen.

Preferably, step (c) is carried out:
(i) With a lower threshold temperature TL of 520° C. and an upper threshold temperature TU of 700° C.;
(ii) For a time period t of from 90 minutes to 6 hours; and
(iii) In the presence of an inert gas, optionally comprising hydrogen.

Step (c) preferably comprises subjecting the particles from step (b) to heat treatment at a temperature of at least 400° C. and in the presence of an inert gas to promote the formation of Si—Si bonds in the silicon domains, to promote the formation of covalent bonds between silicon and the internal surfaces of the porous particle framework while avoiding formation of silicon carbide, to reduce the surface area of the silicon domains, and/or to increase the chemical stability of the silicon domains.

Steps (b), (c) and (d) may be carried out in same reactor vessel. Alternatively, step (b) may be carried out in a first reactor vessel and the particles formed in step (b) may then be transferred to a second reactor vessel for carrying out step (c). The particles may be maintained at a temperature that is less than the temperature in step (b) during transfer to the second reactor vessel. Preferably, the particles are maintained at a temperature of at least 50° C. during transfer to the second reactor vessel. Thereafter, the particles formed in step (c) may be transferred to the first reactor vessel for carrying out step (d). Alternatively, the particles formed in step (c) may be transferred to a third reactor vessel for carrying out step (d).

In one aspect, the invention provides a process for preparing composite particles, the process comprising the steps of:
(a) providing a plurality of porous particles comprising micropores and/or mesopores;
(b) contacting the porous particles with a silicon-containing precursor at a temperature effective to cause deposition of a plurality of nanoscale silicon domains in the pores of the porous particles;
(c) maintaining the particles from step (b) above a lower threshold temperature TL of at least 400° C. for a time period t
(d) contacting the particles from step (c) with a silicon-containing precursor at a temperature effective to cause deposition of further silicon domains in the pores of the porous particles.

Preferably, step (c) comprises maintaining the particles from step (b) between the lower threshold temperature TL and an upper threshold temperature TU for the time period t.

Preferably, the lower threshold temperature TL is 500° C., the upper threshold temperature TU is 700° C., and the time period t is from 90 minutes to 6 hours.

The above aspect of the invention may be optionally combined with any other features disclosed herein in connection with the first aspect of the invention.

Steps (c) and/or (d) may be repeated one or more times.

Composite particles obtained by the process of the invention can be characterised by their performance under thermogravimetric analysis (TGA) in air. This method of analysis relies on the principle that a weight gain is observed when electroactive materials are oxidized in air and at elevated temperature.

As defined herein, “surface silicon” is calculated from the initial mass increase in the TGA trace from a minimum between 150° C. and 500° C. to the maximum mass measured in the temperature range between 550° C. and 650° C., wherein the TGA is carried out in air with a temperature ramp rate of 10° C./min. This mass increase is assumed to result from the oxidation of surface silicon and therefore allows the percentage of surface silicon as a proportion of the total amount of silicon to be determined according to the following formula:

$$Y = 1.875 \times [ ( {M}_{max} - {M}_{min} ) / {M}_{f} ] \times 100 \%$$

Wherein Y is the percentage of surface silicon as a proportion of the total silicon in the sample, Mₘₐₓ is the maximum mass of the sample measured in the temperature range between 550° C. to 650° C., Mₘᵢₙ is the minimum mass of the sample above 150° C. and below 500° C., and M_{f} is the mass of the sample at completion of oxidation at 1400° C. For completeness, it will be understood that 1.875 is the molar mass ratio of SiO₂ to O₂ (i.e. the mass ratio of SiO₂ formed to the mass increase due to the addition of oxygen). Typically, the TGA analysis is carried out using a sample size of 10 mg±2 mg.

It has been found that reversible capacity retention over multiple charge/discharge cycles is considerably improved when the surface silicon as determined by the TGA method described above is at least 20 wt % of the total amount of silicon in the composite particles. Preferably at least 22 wt %, or at least 25 wt %, at least 30 wt % of the silicon, or at least 35 wt % of the silicon, or at least 40 wt % of the silicon, or at least 45 wt % of the silicon is surface silicon as determined by thermogravimetric analysis (TGA).

As used herein, “coarse bulk silicon” is defined as silicon which undergoes oxidation above 800° C. as determined by TGA, wherein the TGA is carried out in air with a temperature ramp rate of 10° C./min. The coarse bulk silicon content is therefore determined according to the following formula:

$$Z = 1.875 \times [ ( {M}_{f} - {M}_{800} ) / {M}_{f} ] \times 100 \%$$

Wherein Z is the percentage of unoxidized silicon at 800° C., M₈₀₀ is the mass of the sample at 800° C., and M_{f} is the mass of ash at completion of oxidation at 1400° C. For the purposes of this analysis, it is assumed that any mass increase above 800° C. corresponds to the oxidation of silicon to SiO₂ and that the total mass at completion of oxidation is SiO₂.

Preferably, no more than 10 wt %, or no more than 8 wt %, or no more than 6 wt %, or no more than 5 wt %, or no more than 4 wt %, or no more than 3 wt %, or no more than 2 wt %, or no more than 1.5 wt % of the silicon in particles formed in the final step (d) is coarse bulk silicon as determined by TGA.

Preferably, at least 30 wt % of the silicon is surface silicon and no more than 10 wt % of the silicon is coarse bulk silicon, wherein both are determined by TGA. More preferably, at least 35 wt % of the silicon is surface silicon and no more than 8 wt % of the silicon is coarse bulk silicon, wherein both are determined by TGA. More preferably, at least 40 wt % of the silicon is surface silicon and no more than 5 wt % of the silicon is coarse bulk silicon, wherein both are determined by TGA. More preferably, at least 45 wt % of the silicon is surface silicon and no more than 2 wt % of the silicon is coarse bulk silicon, wherein both are determined by TGA. It is thought that the process of the invention can produce composite particles with a low content of coarse silicon. Preferably no more than 10 wt % of the silicon, or no more than 8 wt % of the silicon, or no more than 6 wt % of the silicon, or no more than 5 wt %, or no more than 4 wt %, or no more than 3 wt %, or no more than 2 wt % or no more than 1.5 wt % of the silicon in the composite particles formed in the final step (d) is coarse bulk silicon as determined by thermogravimetric analysis (TGA).

The amount of silicon in the composite particles can be determined by elemental analysis. Preferably, elemental analysis is used to determine the elemental composition of the porous particles alone and the composition of the composite particles.

Silicon content is preferably determined by ICP-OES (Inductively coupled plasma-optical emission spectrometry). A number of ICP-OES instruments are commercially available, such as the iCAP® 7000 series of ICP-OES analysers available from ThermoFisher Scientific. The carbon, hydrogen, nitrogen and/or oxygen content of the composite particles and/or of the porous carbon particles are preferably determined by IR absorption. A suitable instrument for determining carbon, hydrogen, nitrogen and/or oxygen content is the TruSpec® Micro elemental analyser available from Leco Corporation.

A range of different silicon loadings in the composite particles may be obtained using the process of the invention. The particles formed in the final step (d) may comprise from 5 to 85 wt %, or from 10 to 85 wt %, or from 15 to 85 wt %, or from 20 to 80 wt %, or from 25 to 80 wt %, or from 30 to 75 wt %, or from 35 to 75 wt %, or from 40 to 70 wt %, or from 45 to 65 wt % of silicon based on the total mass of the particles.

The amount of silicon in the composite particles formed in the final step (d) can be related to the available pore volume in the porous particles by the requirement that the mass ratio of silicon to the porous particles is in the range of from [0.50×P¹ to 1.9×P¹]: 1, wherein P¹ is a dimensionless number having the same value as the total pore volume of micropores and mesopores in the porous particles as measured by gas adsorption as expressed in cm³/g (e.g. if the porous particles have a total volume of micropores and mesopores of 1.2 cm³/g, then P¹=1.2). This relationship takes into account the density of silicon and the pore volume of the porous particles to define a weight ratio of silicon at which the pore volume is around 20% to 82% occupied. Preferably the weight ratio of silicon in the composite particles formed in the final step (d) is from [0.6×P¹ to 1.8×P¹]:1 or from [0.7×P¹ to 1.7×P¹]:1, or from [0.8×P¹ to 1.6×P¹]:1.

The amount of silicon in the composite particles is preferably selected such that at least 25% and up to 90% of the internal pore volume of the porous particles is occupied by the silicon following the final step (d). For example, the silicon may occupy from 25% to 80%, or from 25% to 75%, or from 30% to 70%, or from 35 to 65%, or from 40 to 60%, or from 45% to 55% of the internal pore volume of the porous particles. Within these preferred ranges, the remaining pore volume of the porous particles is effective to accommodate expansion of the electroactive material during charging and discharging, without a large excess pore volume which does not contribute to the volumetric capacity of the particulate particles. However, the amount of electroactive material is also not so high as to impede effective lithiation due to inadequate metal-ion diffusion rates or due to inadequate expansion volume resulting in mechanical resistance to lithiation.

At least 85 wt % of the silicon in the particles formed in the final step (d) may be located within the internal pore volume of the porous particles. Optionally, at least 90 wt %, or at least 95 wt %, or at least 98 wt % of the silicon in the particles formed in the final step (d) is located within the internal pore volume of the porous particles. As discussed above, deposition of silicon in a CVI process occurs at the surfaces of the porous particles. In view of the very high internal surface area of the porous particles, the reaction kinetics of the CVI process ensure that deposition of the silicon occurs almost entirely within the pores of the porous particles. The internal deposition of the silicon is further improved by the requirement that the particles formed in step (b) are subjected to the heat treatment step (c), and then further deposition of silicon occurs in step (d).

The process of the invention may further comprise the step of:
(e) contacting the surface of the particles from the final step (d) with a passivating agent.

As defined herein, a passivating agent is a compound or mixture of compounds which is able to react with the surface of the silicon deposited in the final step (d) to form a modified surface. In particular, a passivating agent as defined herein is a material which is able to react with the surfaces of the silicon to further reduce the surface energy thereof.

The passivating agent may be selected from (i) an oxygen containing gas; (ii) ammonia; (iii) a gas comprising ammonia and oxygen; and (iv) phosphine.

The passivating agent may be selected from:

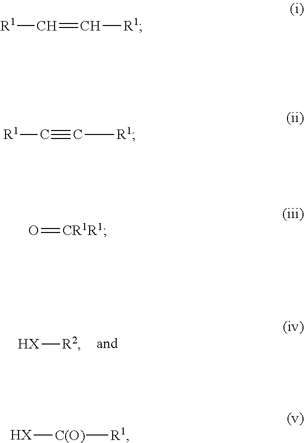

wherein X represents O, S, NR¹ or PR¹; and
wherein each R¹ independently represents H or an unsubstituted or substituted aliphatic or aromatic hydrocarbyl group having from 1 to 20 carbon atoms, or wherein two R¹ groups form an unsubstituted or substituted ring structure comprising from 3 to 8 carbon atoms in the ring;
wherein R² represents an unsubstituted or substituted aliphatic or aromatic hydrocarbyl group having from 1 to 20 carbon atoms, or wherein R¹ and R² together form an unsubstituted or substituted ring structure comprising from 3 to 8 carbon atoms in the ring.

One type of passivation layer is a native oxide layer. A native oxide layer may be formed, for example, by exposing the silicon surface to a passivating agent selected from air or another oxygen containing gas. The passivation layer may comprise a silicon oxide of the formula SiOₓ, wherein 0<x≤2. The silicon oxide is preferably amorphous silicon oxide. The formation of a native oxide layer is exothermic and therefore requires careful process control to prevent overheating or even combustion of the particulate material. In the case that the passivating agent is an oxygen-containing gas, step (c) may comprise cooling the material formed in step (b) to a temperature below 300° C., preferably below 200° C., optionally below 100° C., prior to contacting the silicon surfaces with the oxygen containing gas.

Another type of passivation layer is a nitride layer that is formed, for example, by exposing the silicon surfaces to a passivating agent selected from ammonia or another nitrogen containing molecule. The passivation layer may comprise a silicon nitride of the formula SiNₓ, wherein 0<x≤4/3. The silicon nitride is preferably amorphous silicon nitride. A nitride layer may be formed by contacting the silicon surfaces with ammonia at a temperature in the range from 200-700° C., preferably from 400-700° C., more preferably from 400-600° C. The temperature may then be increased if necessary into the range of 500 to 1,000° C. to form a nitride surface (e.g. a silicon nitride surface of the formula SiNₓ, wherein x≤4/3). Nitride passivation may be preferred to oxide passivation. As sub-stoichiometric nitrides (such as SiNₓ, wherein 0<x≤4/3) are conductive, nitride passivation layers may function as a conductive network that allows for faster charging and discharging of the electroactive material. Phosphine may also be used as a passivating agent, as a phosphorus analog of ammonia.

Another type of passivation layer is an oxynitride layer that is formed, for example, by exposing the silicon surfaces to a passivating agent comprising ammonia (or another nitrogen containing molecule) and oxygen gas. The passivation layer may comprise a silicon oxynitride of the formula SiOₓN_{y}, wherein 0<x<2, 0<y<4/3, and 0< (2x+3y)≤4). The silicon nitride is preferably amorphous silicon oxynitride.

Another type of passivation layer is a carbide layer. The passivation layer may comprise a silicon carbide of the formula SiCₓ, wherein 0<x≤1. The silicon carbide is preferably amorphous silicon carbide. A carbide layer may be formed by contacting the silicon surfaces with a passivating agent selected from carbon containing precursors, e.g. methane or ethylene at elevated temperatures, e.g in the range from 250 to 700° C. At lower temperatures, covalent bonds are formed between the silicon surfaces and the carbon-containing precursors, which are the converted to a monolayer of crystalline silicon carbide as the temperature is increased. The modifier material domains may comprise a silicon carbide of the formula SiCx, wherein 0<x≤1.

Other suitable passivating agents include compounds comprising an alkene, alkyne or carbonyl functional group, more preferably a terminal alkene, terminal alkyne, aldehyde or ketone group.

Particularly preferred passivating agents include one or more compounds of the formulae:

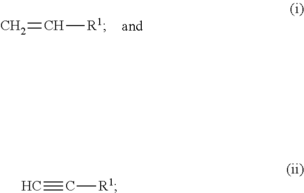

wherein R¹ is as defined above. Preferably, R¹ is unsubstituted.

Examples of suitable passivating agents include ethylene, propylene, 1-butene, butadiene, 1-pentene, 1,4-pentadiene, 1-hexene, 1-octene, styrene, divinylbenzene, acetylene, phenylacetylene, norbornene, norbornadiene and bicyclo[2.2.2]oct-2-ene. Optionally, mixtures of different passivating agents may also be used.

It is believed that passivating agents comprising an alkene, alkyne or carbonyl group undergo an insertion reaction with Si—H groups at the silicon surface to form a covalently passivated surface which is resistant to oxidation by air. The passivation reaction between the silicon surface and the passivating agent may therefore be understood as a form of hydrosilylation, as shown schematically below.

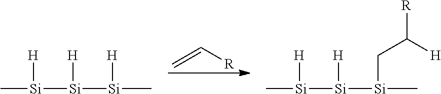

Other suitable passivating agents include compounds including an active hydrogen atom bonded to oxygen, nitrogen, sulphur or phosphorus. For example, the passivating agent may be an alcohol, amine, thiol or phosphine. Reaction of the group-XH with hydride groups at the silicon surfaces is understood to result in elimination of H₂ and the formation of a direct bond between X and the electroactive material surface.

Suitable passivating agents in this category include compounds of the formula

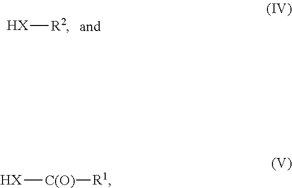

wherein X and each R¹ and R² is independently as defined above.

Preferably X represents O or NH.

Preferably R² represents an optionally substituted aliphatic or aromatic group having from 2 to 10 carbon atoms. Amine groups may also be incorporated into a 4-10 membered aliphatic or aromatic ring structure, as in pyrrolidine, pyrrole, imidazole, piperazine, indole, or purine.

Another suitable passivating agent is water. For example, the silicon surface may be exposed to water vapour. Alternatively, the particles from step (d) may be immersed in water. Optionally, passivation using one or more of the passivating agents disclosed above may be followed by passivation with water.

Preferably, step (e) is carried out with a passivating agent other than air.

Step (e) may be carried out at a temperature in the range of 25 to 500° C., preferably at a temperature in the range of from 50 to 450° C., more preferably from 100 to 400° C.

The process of the invention may further comprise the step of:
(f) combining the particles from the final step (d) or step (e) with a pyrolytic carbon precursor; and heating the pyrolytic carbon precursor to a temperature effective to cause the deposition of a conductive pyrolytic carbon material into the pores and/or onto the outer surface of the composite particles.

In the case that step (e) is included in the process, step (f) may optionally be performed before or after step (e). In every case, step (f) is performed after the final step (d).

The pyrolytic carbon precursor is preferably a hydrocarbon. Suitable hydrocarbons include polycyclic hydrocarbons comprising from 10 to 25 carbon atoms and optionally from 1 to 3 heteroatoms, optionally wherein the polyaromatic hydrocarbon is selected from naphthalene, substituted naphthalenes such as di-hydroxynaphthalene, anthracene, tetracene, pentacene, fluorene, acenapthene, phenanthrene, fluoranthrene, pyrene, chrysene, perylene, coronene, fluorenone, anthraquinone, anthrone and alkyl-substituted derivatives thereof. Suitable pyrolytic carbon precursors also include bicyclic monoterpenoids, optionally wherein the bicyclic monoterpenoid is selected from camphor, borneol, eucalyptol, camphene, careen, sabinene, thujene and pinene. Further suitable pyrolytic carbon precursors include C₂-C₁₀ hydrocarbons, optionally wherein the hydrocarbons are selected from alkanes, alkenes, alkynes, cycloalkanes, cycloalkenes, and arenes, for example methane, ethylene, propylene, limonene, styrene, cyclohexane, cyclohexene, α-terpinene and acetylene. Other suitable pyrolytic carbon precursors include phthalocyanine, sucrose, starches, graphene oxide, reduced graphene oxide, pyrenes, perhydropyrene, triphenylene, tetracene, benzopyrene, perylenes, coronene, and chrysene. A preferred carbon precursor is acetylene.

A suitable temperature for the deposition of a pyrolytic carbon material in step (f) is in the range from 300 to 800° C., or from 400 to 700° C. For example, the temperature may be no more than 680° C. or no more than 660° C., or no more than 640° C. or no more than 620° C., or no more than 600° C., or no more than 580° C., or no more than 560° C., or no more than 540° C., or no more than 520° C., or no more than 500° C. The minimum temperature will depend on the type of carbon precursor that is used. Preferably, the temperature is at least 300° C., or at least 350° C., or at least 400° C., or at least 450° C., or at least 500° C.

The pyrolytic carbon precursor used in step (f) may be used in pure form, or diluted mixture with an inert carrier gas, such as nitrogen or argon. For instance, the pyrolytic carbon precursor may be used in an amount in the range from 0.1 to 100 vol %, or 0.5 to 20 vol %, or 1 to 10 vol %, or 1 to 5 vol % based on the total volume of the precursor and the inert carrier gas.

In the case that a pyrolytic carbon material is deposited in step (f), the same compound may function as both a passivating agent in step (e) and the pyrolytic carbon precursor in step (f). For example, if styrene is selected as the pyrolytic carbon precursor, then it will also function as a passivating agent if the particles from step (d) are not exposed to another passivating agent prior to contact with styrene. In this case, passivation and deposition of the conductive pyrolytic carbon material in steps may be carried out simultaneously, for example at a temperature in the range of from 300-700° C. Alternatively, passivation and deposition of the conductive pyrolytic carbon material may be carried out sequentially, with the same material as the passivating agent and the pyrolytic carbon precursor, but wherein step (f) is carried out at a higher temperature than, and following, the passivation in step (e). For example, passivation in step (e) may be carried out at a temperature in the range of from 25° C. to less than 300° C., and deposition of pyrolytic carbon may be carried out at a temperature in the range from 300-700° C. These two steps may suitably be carried out sequentially by increasing the temperature while maintaining contact with the compound that functions as both a passivating agent and the pyrolytic carbon precursor. At lower temperatures (e.g. in the range of 25° C. to <300° C.) passivation will be the primary process. As the temperature is increased (e.g. to 300-700° C.) the deposition of pyrolytic carbon will ensue.

The process of the reaction may be carried out using any reactor that is capable of contacting solids and gases at elevated temperature. The porous particles and the forming composite particles may be present in the reactor in the form of a static bed of particles, or in the form of a moving or agitated bed of particles.

In a second aspect, the invention provides a particulate material consisting of a plurality of composite particles obtainable by the process of the first aspect.

In a third aspect of the invention, there is provided a composition comprising the particulate material of the second aspect of the invention and at least one other component. The at least one other component may be one or more of: (i) a binder; (ii) a conductive additive; and (iii) an additional particulate electroactive material. The composition according to the third aspect of the invention is useful as an electrode composition, and thus may be used to form the active layer of an electrode.

The composition may be a hybrid electrode composition which comprises the composite particles and at least one additional particulate electroactive material. Examples of additional particulate electroactive materials include graphite, hard carbon, silicon, tin, germanium, aluminium and lead. The at least one additional particulate electroactive material is preferably selected from graphite and hard carbon, and most preferably the at least one additional particulate electroactive material is graphite.

In the case of a hybrid electrode composition, the composition preferably comprises from 3 to 60 wt %, or from 3 to 50 wt %, or from 5 to 50 wt %, or from 10 to 50 wt %, or from 15 to 50 wt %, of the particulate material according to the second aspect of the invention, based on the total dry weight of the composition.

The at least one additional particulate electroactive material is suitably present in an amount of from 20 to 95 wt %, or from 25 to 90 wt %, or from 30 to 75 wt % of the at least one additional particulate electroactive material.

The at least one additional particulate electroactive material preferably has a D₅₀ particle diameter in the range from 10 to 50 μm, preferably from 10 to 40 μm, more preferably from 10 to 30 μm and most preferably from 10 to 25 μm, for example from 15 to 25 μm.

The D₁₀ particle diameter of the at least one additional particulate electroactive material is preferably at least 5 μm, more preferably at least 6 μm, more preferably at least 7 μm, more preferably at least 8 μm, more preferably at least 9 μm, and still more preferably at least 10 μm.

The D₉₀ particle diameter of the at least one additional particulate electroactive material is preferably up to 100 μm, more preferably up to 80 μm, more preferably up to 60 μm, more preferably up to 50 μm, and most preferably up to 40 μm.

The at least one additional particulate electroactive material is preferably selected from carbon-comprising particles, graphite particles and/or hard carbon particles, wherein the graphite and hard carbon particles have a D₅₀ particle diameter in the range from 10 to 50 μm. Still more preferably, the at least one additional particulate electroactive material is selected from graphite particles, wherein the graphite particles have a D₅₀ particle diameter in the range from 10 to 50 μm.

The composition may also be a non-hybrid (or “high loading”) electrode composition which is substantially free of additional particulate electroactive materials. In this context, the term “substantially free of additional particulate electroactive materials” should be interpreted as meaning that the composition comprises less than 15 wt %, preferably less than 10 wt %, preferably less than 5 wt %, preferably less than 2 wt %, more preferably less than 1 wt %, more preferably less than 0.5 wt % of any additional electroactive materials (i.e. additional materials which are capable of inserting and releasing metal ions during the charging and discharging of a battery), based on the total dry weight of the composition.

A “high-loading” electrode composition of this type preferably comprises at least 50 wt %, or at least 60 wt %, or at least 70 wt %, or at least 80 wt %, or at least 90 wt % of the particulate material of the second aspect of the invention, based on the total dry weight of the composition.

The composition may optionally comprise a binder. A binder functions to adhere the composition to a current collector and to maintain the integrity of the composition. Examples of binders which may be used in accordance with the present invention include polyvinylidene fluoride (PVDF), polyacrylic acid (PAA) and alkali metal salts thereof, modified polyacrylic acid (mPAA) and alkali metal salts thereof, carboxymethylcellulose (CMC), modified carboxymethylcellulose (mCMC), sodium carboxymethylcellulose (Na-CMC), polyvinylalcohol (PVA), alginates and alkali metal salts thereof, styrene-butadiene rubber (SBR) and polyimide. The composition may comprise a mixture of binders. Preferably, the binder comprises polymers selected from polyacrylic acid (PAA) and alkali metal salts thereof, and modified polyacrylic acid (mPAA) and alkali metal salts thereof, SBR and CMC.

The binder may suitably be present in an amount of from 0.5 to 20 wt %, preferably 1 to 15 wt %, preferably 2 to 10 wt % and most preferably 5 to 10 wt %, based on the total dry weight of the composition.

The binder may optionally be present in combination with one or more additives that modify the properties of the binder, such as cross-linking accelerators, coupling agents and/or adhesive accelerators.

The composition may optionally comprise one or more conductive additives. Preferred conductive additives are non-electroactive materials that are included so as to improve electrical conductivity between the electroactive components of the composition and between the electroactive components of the composition and a current collector. The conductive additives may be selected from carbon black, carbon fibers, carbon nanotubes, graphene, acetylene black, ketjen black, metal fibers, metal powders and conductive metal oxides. Preferred conductive additives include carbon black and carbon nanotubes.

The one or more conductive additives may suitably be present in a total amount of from 0.5 to 20 wt %, preferably 1 to 15 wt %, preferably 2 to 10 wt % and most preferably 5 to 10 wt %, based on the total dry weight of the composition.

In a fourth aspect, the invention provides an electrode comprising the particulate material according to the second aspect of the invention or the composition of the third aspect of the invention. The particulate material may be in electrical contact with a current collector.

As used herein, the term current collector refers to any conductive substrate that is capable of carrying a current to and from the electroactive particles in the composition. Examples of materials that can be used as the current collector include copper, aluminium, stainless steel, nickel, titanium and sintered carbon. Copper is a preferred material. The current collector is typically in the form of a foil or mesh having a thickness of between 3 to 500 μm. The particulate materials of the invention may be applied to one or both surfaces of the current collector to a thickness which is preferably in the range from 10 μm to 1 mm, for example from 20 to 500 μm, or from 50 to 200 μm.

The electrode of the fourth aspect of the invention may be fabricated by combining the particulate material of the second aspect of the invention with a solvent and optionally one or more viscosity modifying additives to form a slurry. The slurry is then cast onto the surface of a current collector and the solvent is removed, thereby forming an electrode layer on the surface of the current collector. Further steps, such as heat treatment to cure any binders and/or calendaring of the electrode layer may be carried out as appropriate. The electrode layer suitably has a thickness in the range from 20 μm to 2 mm, preferably 20 μm to 1 mm, preferably 20 μm to 500 μm, preferably 20 μm to 200 μm, preferably 20 μm to 100 μm, preferably 20 μm to 50 μm.

Alternatively, the slurry may be formed into a freestanding film or mat comprising the particulate material of the invention, for instance by casting the slurry onto a suitable casting template, removing the solvent and then removing the casting template. The resulting film or mat is in the form of a cohesive, freestanding mass that may then be bonded to a current collector by known methods.

The electrode of the fourth aspect of the invention may be used as the anode of a metal-ion battery. Thus, in a fifth aspect, the present invention provides a rechargeable metal-ion battery comprising the electrode of the fourth aspect as the anode.

The metal ions are preferably lithium ions. More preferably, the rechargeable metal-ion battery of the invention is a lithium-ion battery, and the cathode active material is capable of releasing and accepting lithium ions.

The cathode of the rechargeable metal-ion battery typically comprises a current collector and a cathode active material capable of releasing and reabsorbing metal ions. The cathode active material is preferably a metal oxide-based composite. Examples of suitable cathode active materials include LiCoO₂, LiCo_{0.99}Al_{0.01}O₂, LiNiO₂, LiMnO₂, LiCO_{0.5}Ni_{0.5}O₂, LiCo_{0.7}Ni_{0.3}O₂, LiCo_{0.8}Ni_{0.2}O₂, LiCo_{0.82}Ni_{0.18}O₂, LiCo_{0.8} Ni_{0.15}Al_{0.05}O₂, LiNi_{0.4}Co_{0.3}Mn_{0.3}O₂ and LiNi_{0.33}Co_{0.33}Mn_{0.34}O₂. The cathode current collector is generally of a thickness of between 3 to 500 μm. Examples of materials that can be used as the cathode current collector include aluminium, stainless steel, nickel, titanium and sintered carbon.

A suitable electrolyte is a non-aqueous electrolyte containing a metal salt, e.g. a lithium salt, and may include, without limitation, non-aqueous electrolytic solutions, solid electrolytes and inorganic solid electrolytes. Examples of non-aqueous electrolyte solutions that can be used include non-protic organic solvents such as propylene carbonate, ethylene carbonate, butylene carbonates, dimethyl carbonate, diethyl carbonate, gamma butyrolactone, 1,2-dimethoxyethane, 2-methyltetrahydrofuran, dimethylsulfoxide, 1,3-dioxolane, formamide, dimethylformamide, acetonitrile, nitromethane, methylformate, methyl acetate, phosphoric acid triesters, trimethoxymethane, sulfolane, methyl sulfolane and 1,3-dimethyl-2-imidazolidinone.

Examples of organic solid electrolytes include polyethylene derivatives polyethyleneoxide derivatives, polypropylene oxide derivatives, phosphoric acid ester polymers, polyester sulfide, polyvinylalcohols, polyvinylidine fluoride and polymers containing ionic dissociation groups.

Examples of inorganic solid electrolytes include nitrides, halides and sulfides of lithium salts such as Li₅NI₂, Li₃N, LiI, LiSiO₄, Li₂SiS₃, Li₄SiO₄, LiOH and Li₃PO₄.

The lithium salt is suitably soluble in the chosen solvent or mixture of solvents. Examples of suitable lithium salts include LiCl, LiBr, LiI, LiClO₄, LiBF₄, LiBC₄O₈, LiPF₆, LiCF₃SO₃, LiAsF₆, LiSbF₆, LiAlCl₄, CH₃SO₃Li and CF₃SO₃Li.

Where the electrolyte is a non-aqueous organic solution, the metal-ion battery is preferably provided with a separator interposed between the anode and the cathode. The separator is typically formed of an insulating material having high ion permeability and high mechanical strength. The separator typically has a pore diameter of between 0.01 and 100 μm and a thickness of between 5 and 300 μm. Examples of suitable electrode separators include a micro-porous polyethylene film.

The separator may be replaced by a polymer electrolyte material and in such cases the polymer electrolyte material is present within both the composite anode layer and the composite cathode layer. The polymer electrolyte material can be a solid polymer electrolyte or a gel-type polymer electrolyte.

### EXAMPLES

### Example 1

Silicon carbon composite Sample A (30 g) was loaded into a furnace tube. The furnace tube was sealed and then purged with nitrogen (0.3 L/min) for 30 min. The furnace tube was heated to target temperature (650° C.) under nitrogen (0.3 L/min) over 97 min.

The silicon carbon composite was then annealed at 650° C. for 90 min under nitrogen (0.5 L/min). The furnace temperature was then cooled to room temperature under nitrogen (0.5 L/min).

Subsequently, the annealed material was passivated at room temperature under a flow of nitrogen (0.2 L/min) and air (0.3 L/min) for 35 min, followed by a flow of air (0.5 L/min) for 90 min.

The resulting powder was submitted for characterisation as Sample B.

Characterisation of Samples A and B is provided in Table 1 below. Sample A is the silicon carbon composite used to make Sample B.

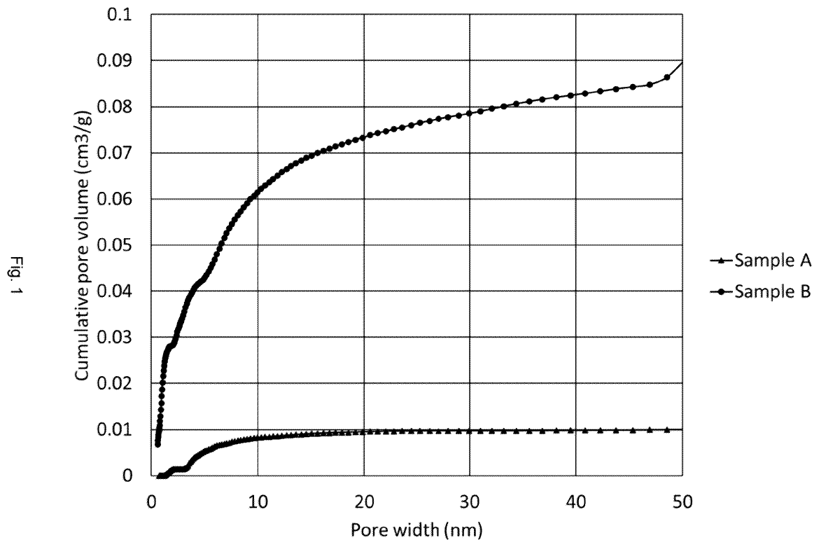

The cumulative pore volumes (cm³/g) of Samples A and B are shown in FIG. 1.

TABLE 1
Characterisation of Sample A and B

| | | | | Surface |
|---|---|---|---|---|
| | | Hydrogen | Silicon | silicon |
| | BET Surface | content/% | content/% | content/% |
| Sample | area/m²/g | w/w | w/w | w/w |
| A | 11.4 | 0.97 | 55.0 | 47.7 |
| B | 125.7 | 0.58 | 50.7 | 43.0 |

### Example 2

Silicon carbon composite Sample C (40 g) was loaded into a rotary kiln tube. The rotary kiln tube was sealed and then purged with nitrogen (0.3 L/min) for 30 min. The furnace tube was heated to target temperature (520° C.) under nitrogen (0.3 L/min) over 80 mins and allowed to stabilise for 10 min.

Nitrogen flow was increased to 0.66 L/min, rotation increased to 50 rpm and the silicon carbon composite was annealed for 180 min. The furnace was then cooled to room temperature.

The annealed material was then passivated at room temperature under a flow of nitrogen (0.2 L/min) and air (0.3 L/min) for 30 min, followed by a flow of air (0.5 L/min) for 30 min.

The resulting powder was submitted for characterisation as Sample D.

Samples E-F were prepared using the methods described for Sample D and the conditions outlined in Table 2 below. Characterisation of Samples C-F is provided in Table 3 below. Sample C is the silicon carbon composite used to make Samples D-F.

TABLE 2
Annealing conditions for Samples D-F

| | Annealing | Annealing | Annealing |
|---|---|---|---|
| Sample | atmosphere | temperature/° C. | time/min |
| D | Nitrogen | 520 | 180 |
| E | Nitrogen | 520 | 90 |
| F | Nitrogen (0.25 | 520 | 180 |
| | L/min) and | | |
| | hydrogen (0.25 | | |
| | L/min) mixture | | |

TABLE 3
Characterisation of Samples C-F

| | | | | Surface |
|---|---|---|---|---|
| | | Hydrogen | Silicon | silicon |
| | BET Surface | content/% | content/% | content/% |
| Sample | area/m²/g | w/w | w/w | w/w |
| C | 23.3 | 0.80 | 50.4 | 63.0 |
| D | 23.5 | 0.39 | 47.4 | 55.0 |
| E | 21.7 | 0.34 | 48.0 | 59.0 |
| F | 21.4 | 0.52 | 49.3 | 64.0 |

As shown in Tables 1 and 3, the content of hydrogen is reduced as a result of annealing.

Addition of hydrogen to the annealing atmosphere (as in Sample F) results in increased retention of hydrogen within the structure and thus, a surface silicon content more similar to baseline silicon carbon composite Sample C.

1. A process for preparing composite particles, the process comprising the steps of:
(a) providing a plurality of porous particles comprising micropores and/or mesopores;
(b) contacting the porous particles with a silicon-containing precursor at a temperature effective to cause deposition of a plurality of silicon domains in the pores of the porous particles;
(c) subjecting the particles from step (b) to heat treatment at a temperature of at least 400° C. and in the presence of an inert gas;
(d) contacting the particles from step (c) with a silicon-containing precursor at a temperature effective to cause deposition of further silicon domains in the pores of the porous particles.

2-12. (canceled)

13. A process according to claim 1, wherein no more than 10 wt % of the silicon, or no more than 8 wt % of the silicon, or no more than 6 wt % of the silicon, or no more than 5 wt %, or no more than 4 wt %, or no more than 3 wt %, or no more than 2 wt % or no more than 1.5 wt % of the silicon in particles formed in the final step (d) is coarse bulk silicon as determined by thermogravimetric analysis (TGA).

14. A process according to claim 1, wherein steps (b) and/or (d) are independently carried out at a temperature in the range from 340 to 500° C., or from 350 to 480° C., or from 350 to 450° C., or from 350 to 420° C., or from 350 to less than 400° C., or from 355 to 395° C., or from 360 to 390° C., or from 360 to 385° C., or from 360 to 380° C., preferably steps (b) and/or (d) are independently carried out at a temperature in the range from 340 to less than 400° C., or from 370 to 395° C.

15. (canceled)

16. A process according to claim 1, wherein the ratio of BET surface area of the particles formed in step (c) to BET surface area of the particles formed in step (b) is at least 1.1:1, or at least 1.2:1, or at least 1.3:1, or at least 1.4:1, or at least 1.5:1, or at least 2:1, or at least 3:1, or at least 4:1, or at least 5:1.

17. (canceled)

18. A process according to claim 1, wherein the ratio of total pore volume of micropores and mesopores as measured by gas adsorption of the particles formed in step (c) to total pore volume of micropores and mesopores as measured by gas adsorption of the particles formed in step (b) is at least 2:1, or at least 3:1, or at least 4:1, or at least 5:1, or at least 6:1, or at least 7:1, or at least 8:1.

19. (canceled)

20. A process according to claim 1, wherein the ratio of total hydrogen content of the particles formed in step (c) to total hydrogen content of the particles formed in step (b) is no more than 0.8:1, or no more than 0.7:1, or no more than 0.6:1, or no more than 0.5:1.

21. (canceled)

22. A process according to claim 1, wherein the inert gas used in step (c) is selected from the group consisting of nitrogen, argon, helium and combinations thereof.

23. (canceled)

24. A process according to claim 1, wherein step (c) is carried out in the presence of nitrogen and hydrogen.

25. A process according to claim 1, wherein the temperature in step (c) is greater than the temperature in step (b), optionally, wherein the temperature in step (c) is at least 20° C., or at least 40° C., or at least 60° C., or at least 80° C., or at least 100° C., or at least 120° C., or at least 140° C., or at least 150° C. greater than the temperature in step (b).

26. A process according to claim 1, wherein the temperature in step (c) is at least 450° C., or at least 500° C., or at least 510° C., or at least 520° C., or at least 540° C., or at least 560° C., or at least 580° C., or at least 600° C., or at least 610° C., or at least 620° C., or at least 630° C., or at least 640° C., or at least 650° C., preferably wherein the temperature in step (c) is at least 500° C., more preferably wherein the temperature in step (c) is at least 510° C., more preferably wherein the temperature in step (c) is at least 520° C.

27. A process according to claim 1, wherein the temperature in step (c) is no more than 900° C., or no more than 850° C., or no more than 800° C., or no more than 750° C., or no more than 700° C., or no more than 680° C., or no more than 660° C., or no more than 650° C., preferably wherein the temperature in step (c) is no more than 750° C., more preferably wherein the temperature in step (c) is no more than 700° C.

28. A process according to claim 1, wherein step (c) is carried out for a period of at least 1 minute, or at least 2 minutes, or at least 5 minutes, or at least 10 minutes, or at least 15 minutes, or at least 20 minutes, or at least 30 minutes, or at least 45 minutes, or at least 1 hour, or at least 2 hours, preferably wherein step (c) is carried out for a period of at least 30 minutes, more preferably wherein step (c) is carried out for a period of at least 1 hour, more preferably wherein step (c) is carried out for a period of at least 90 minutes.

29. A process according to claim 1, wherein step (c) is carried out for a period of no more than 72 hours, or no more than 48 hours, or no more than 24 hours, or no more than 12 hours, or no more than 6 hours, or no more than 5 hours, or no more than 4 hours, or no more than 3 hours, preferably wherein step (c) is carried out for a period of no more than 24 hours, more preferably wherein step (c) is carried out for a period of no more than 12 hours, more preferably wherein step (c) is carried out for a period of no more than 6 hours.

30. A process according to claim 1, wherein step (c) comprises maintaining the particles from step (b) above a lower threshold temperature TL of at least 400° C. for a time period t, preferably step (c) comprises maintaining the particles from step (b) between the lower threshold temperature TL and an upper threshold temperature TU for the time period t.

31. A process according to claim 30, wherein the lower threshold temperature TL is 500° C., the upper threshold temperature TU is 700° C., and the time period t is from 90 minutes to 6 hours.

32. A process according to claim 1, wherein steps (c) and/or (d) are repeated one or more times.

33. A process according to claim 1, wherein the weight ratio of silicon in the particles formed in step (d) to the porous particles is in the range of from [0.50×P¹ to 1.9×P¹]: 1, or from [0.6×P¹ to 1.8×P¹]: 1 or from [0.7×P¹ to 1.7×P¹]: 1, or from [0.8×P¹ to 1.6×P¹]: 1, wherein P¹ is a dimensionless number having the same value as the total pore volume of micropores and mesopores in the porous particles as measured by gas adsorption as expressed in cm³/g.

34. A process according to claim 1, wherein the particles formed in the final step (d) comprise from 5 to 85 wt %, or from 10 to 85 wt %, or from 15 to 85 wt %, or from 20 to 80 wt %, or from 25 to 80 wt %, or from 30 to 75 wt %, or from 35 to 75 wt %, or from 40 to 70 wt %, or from 45 to 65 wt % of silicon based on the total mass of the particles.

35-42. (canceled)

43. A process according to claim 1, further comprising the step of:
(e) contacting the surface of the particles from the final step (d) with a passivating agent.

44. A process according to claim 43, wherein the passivating agent is selected from (i) an oxygen containing gas; (ii) ammonia; (iii) a gas comprising ammonia and oxygen; (iv) phosphine; (v) water; (vi) R¹—CH═CH—R¹; (vii) R¹—C≡C—R¹; (viii) O═CR¹R¹; (ix) HX—R², and (x) HX—C(O)—R¹,
wherein X represents O, S, NR¹ or PR¹; and
wherein each R¹ independently represents H or an unsubstituted or substituted aliphatic or aromatic hydrocarbyl group having from 1 to 20 carbon atoms, or wherein two R¹ groups form an unsubstituted or substituted ring structure comprising from 3 to 8 carbon atoms in the ring;
wherein R² represents an unsubstituted or substituted aliphatic or aromatic hydrocarbyl group having from 1 to 20 carbon atoms, or wherein R¹ and R² together form an unsubstituted or substituted ring structure comprising from 3 to 8 carbon atoms in the ring.

45. (canceled)

46. (canceled)

47. A process according to claim 1, further comprising the step of:
(f) combining the particles from the final step (d) or step (e) with a pyrolytic carbon precursor; and heating the pyrolytic carbon precursor to a temperature effective to cause the deposition of a conductive pyrolytic carbon material into the pores and/or onto the outer surface of the composite particles.

48-51. (canceled)
